(19) United States
(12) Patent Application Publication
(10) Pub. No.: US 2013/0080256 A1
(43) Pub. Date: Mar. 28, 2013

(54) TELEPRESENCE SYSTEM FOR PROVIDING INFORMATION TO A USER THROUGH AN AGENT BASED ON THE LOCATION OF THE AGENT

(71) Applicant: GREGORY A. PICCIONELLI, ENCINO, CA (US)

(72) Inventor: GREGORY A. PICCIONELLI, ENCINO, CA (US)

(21) Appl. No.: 13/624,401

(22) Filed: Sep. 21, 2012

Related U.S. Application Data
(60) Provisional application No. 61/626,343, filed on Sep. 22, 2011.
(60) Provisional application No. 61/626,787, filed on Oct. 3, 2011.

(51) Int. Cl. G06Q 30/02; H04W 4/02

(52) U.S. Cl. 705/14.58; 455/414.1

(57) ABSTRACT

Described is a telepresence system for providing information to a user through an agent based on the location of the agent, which is remote to a location of the user. The telepresence system is in signal communication with the Internet and a wireless communication network.

### CROSS-REFERENCE TO RELATED APPLICATIONS

This application claims priority, under 35 U.S.C. §119(e), to both U.S. Provisional Patent Application Ser. No. 61/626,343, titled “SYSTEM AND PROCESS FOR PROVIDING INFORMATION, SUCH AS ADVERTISING, BY ONE OR MORE INFORMATION PROVIDERS TO ONE OR MORE RECIPIENTS BASED ON THE LOCATION OF ONE OR MORE THIRD PARTIES,” filed Sep. 22, 2011, and U.S. Provisional Patent Application Ser. No. 61/626,787, titled “SYSTEM AND PROCESS FOR PROVIDING INFORMATION, SUCH AS ADVERTISING, BY ONE OR MORE INFORMATION PROVIDERS TO ONE OR MORE RECIPIENTS BASED ON THE LOCATION OF ONE OR MORE THIRD PARTIES,” filed Oct. 3, 2011, both of which are herein incorporated by reference in their entirety.

### BACKGROUND OF THE INVENTION

1. Field of the Invention

This invention relates generally to communication systems, and in particular, to telepresence communication systems.

2. Related Art

Network communications has become common in modern society. Systems utilizing network communications include, for example, systems that allow network communication on the Internet and cellular networks, wireless communication systems, and telepresence systems that utilize telepresence technologies.

Wireless communication devices have evolved from simple analog radios to modern cellular telephones, personal digital assistants (“PDAs”), smartphones, portable computers, and tablets. As these wireless communication devices continue to evolve, manufactures and software developers are continuously improving the input devices (i.e., microphones, cameras, keyboards, wireless connectivity, such as Bluetooth® and Wi-Fi® technologies) and software applications available to these wireless communication devices. These wireless communication devices allow users to use both cellular communication networks and the Internet for such activities as voice calls, Internet surfing, texting, tweets, emailing, etc.

Additionally, many modern wireless communication devices are also including location determination technologies (“LDT”) circuitry that may include, for example, a global positioning system (“GPS”) module, an aided location communication system, a multilateration module, a Wi-Fi® identification module, or combination of these technologies that allow the determination of a location of specific wireless communication device. An example of an aided location communication system is described in U.S. Pat. No. 7,970,412, titled “AIDED LOCATION COMMUNICATION SYSTEM,” issued on Jun. 28, 2011, which is herein incorporated by reference in its entirety.

With the advent of LDT, many wireless services have included mapping and pushing applications that include business information or push advertising to the wireless communication device based on the location of the wireless device. At present, there are numerous technologies that provide for transmission of information from an information provider to a user of wireless communication device based on the location of the wireless communication device.

Similar to wireless communication devices, network communication on the Internet and cellular networks has also evolved from simple text and voice communication to advanced forms of human communication and interaction. Modern Internet online service platforms such as existing social networking services (for example Facebook®, Twitter®, Google+®, etc.) have established a need for online services that facilitate the building of social networks and/or social relations among people who, for example, share interests, ideas, activities, events, backgrounds, or real-life connections. These online service platforms also seem to have an increasing amount of influence on peoples' identity, privacy, social capital, culture, education, and human interaction both real and virtual.

One result of the Internet has been the ability for many Internet users to experience virtual travel, communicate in various forums, obtain news, establish personal relationships online, and purchase and perform other financial transactions without ever leaving their respective locations. For example, people view live webcams of far off locations; read and post on blogs, forums, and websites; read online newspapers and watch online television and news clips; post and communicate on dating online services; buy from online stores; and bank or make payments via online websites.

Turning to telepresence, telepresence technologies have evolved from being mostly government program applications to everyday applications utilized by businesses and normal people. In general, telepresence technologies allow a person to feel as if they were present, to give the appearance of being present to others, or to have the effect, via telerobotics, at a place other than their true location. One of the most common telepresence technologies is video conferencing that allows two parties to communicate via a two-way video link that gives a somewhat appearance and feel of having both parties physically present in the same location. Technical advances in mobile wireless devices has enabled many handheld mobile devices, such as, for example, iPhones®, iPad®, Android® based mobile devices, and Microsoft® based mobile devices to video conference in a way that allows collaboration between users that is independent of the users' individual locations.

Telerobotics is a telepresence technology that is an area of robotics concerned with the control of robots from a distance chiefly using wireless connections, tethered connections, or the Internet. Examples of the wireless connections includes, for example, Wi-Fi®, Bluetooth®, and the Deep Space Network used by government space agencies such as NASA. In general, telerobotics is a combination of teleoperation and telepresence where teleoperation means doing work at a distance. Within telerobotics, a telemanipulator (or teleoperator) is a device that is controlled remotely by a human operator.

As telepresence technologies are developed whereby a party controls another party remotely to provide to the user party the ability to remotely shop and engage in other activities, a need exists to provide information to the user, not on the basis of the user's location, but on the basis of the location of the user's agent who is in a remote location.

### SUMMARY

Described is a telepresence system for providing information to a user through an agent based on the location of the agent, which is remote to a location of the user. The telepresence system is in signal communication with the Internet and a wireless communication network. In general, the telepresence system includes a client module, an agent module, and a server. The client module may be in signal communication with an online device of the user and the agent module may be in signal communication with a wireless device of the agent. The server may be in signal communication with the client module, agent module, and both the Internet and wireless communication network. In general, the server may be configured to receive requests from a user via the Internet and location information from the agent via the cellular telecommunication network and, in response, provide telepresence information from the agent to the user.

The telepresence system allows a user to establish a telepresence with an agent via the Internet and a cellular communication network. In an example of operation, the telepresence system performs a process that includes establishing communication between the user and the agent via the Internet and cellular communication network and passing requests from the user to the agent via an online device in signal communication with the Internet. The system also passes telepresence information from the agent to the user via a wireless device in signal communication with the cellular network, wherein the cellular communication network is in signal communication with the Internet.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a system diagram of an example of an implementation of a telepresence system, in accordance with the invention, for providing information to a user through an agent based on the location of the agent, which is remote to the location of the user.

FIG. 2 is a system block diagram of the example of the implementation of the telepresence system, shown in FIG. 1, including a client module and an agent module, in accordance with the invention.

FIG. 3 shows a perspective view of the respective locations of the agent and a registered target are shown in relation to a pre-determined positive location area in accordance with the invention.

FIG. 4 shows a system view of an example of a video transmission from an agent to an online device of a user utilizing the telepresence system as shown in FIG. 1.

FIG. 5 shows a system view of an example of a video transmission from an agent and service provider to an online device of a user when the agent enters into a pre-determined positive location area utilizing the telepresence system as shown in FIG. 1.

FIG. 6 shows a perspective view of the respective locations of the agent and a registered target are shown in relation to a pre-determined negative location in accordance with the invention.

FIG. 7 is a flowchart of an example of an implementation of a process performed by a picture-to-logo converter, in accordance with the present invention.

### DETAILED DESCRIPTION OF THE INVENTION

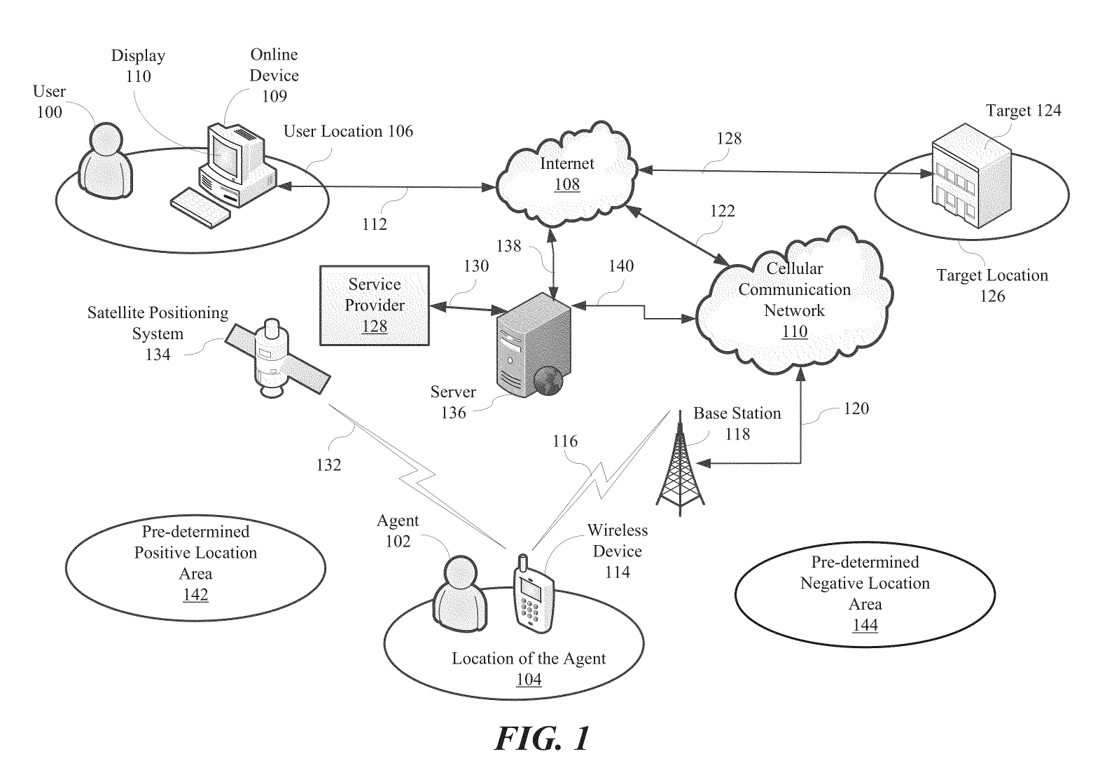

In FIG. 1, a system diagram of an example of an implementation of a telepresence system is shown, in accordance with the invention, for providing information to a user 100 through an agent 102 based on the location 104 of the agent 102, which is remote to the location 106 of the user 100. The telepresence system is in signal communication with the Internet 108 and a wireless communication network 110. In this example, the user 100 may utilize an online device 109, having a display 110, to communicate with the Internet 108 via signal path 112. The agent 102 may utilize a wireless device 114 to communicate with the cellular communication network 110 via a signal path that includes a wireless signal path 116 to a base station 118, which is in signal communication with the cellular communication network 110 via signal path 120. The cellular communication network 110 may be in signal communication with the Internet 108 via signal path 122. The telepresence system may also be in signal communication with a target 124, located at a target location 126, and a service provider 126 via signal paths 128 and 130, respectively.

It is appreciated by those skilled in the art that the circuits, components, modules, and/or devices of the telepresence system are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

Turning back to FIG. 1, the online device 109 may be any computing device capable of connecting to the Internet 108 and having a display 110 capable of showing images or video captured by wireless device 114 of the agent 102 or provided by the service provider 126. Examples of the online device 109 may include a personal computer (both portable and non-portable), a computer tablet (such as, for example, an iPad®, Andriod® based tablet, or Microsoft® based tablet), a personal digital assistant (“PDA”), or smartphone (such as, for example, an iPhone®, Andriod® based smartphone, or Microsoft® based smartphone), or any other equivalent device. Similarly, examples of the wireless device 114 of the agent 102 may include a portable computer, a computer tablet (such as, for example, an iPad®, Andriod® based tablet, or Microsoft® based tablet), a personal digital assistant (“PDA”), or smartphone (such as, for example, an iPhone®, Andriod® based smartphone, or Microsoft® based smartphone), or any other equivalent device. The wireless device 114 may also be incorporated into the agent 102 such as a module in a non-human agent 102 or in a wearable device or configuration (such as, for example, a helmet, headpiece, or wearable accessory) if the agent 102 is human. The wireless device 114 may also include location determination technology (“LDT”) circuitry that may include, for example, a global positioning system (“GPS”) module, an aided location communication system, a multilateration module, a Wi-Fi® identification module, or combination of these technologies that allow the determination of a location of specific wireless communication device. An example of an aided location communication system is described in U.S. Pat. No. 7,970,412, titled “AIDED LOCATION COMMUNICATION SYSTEM,” issued on Jun. 28, 2011, which is herein incorporated by reference in its entirety. In this example, the wireless device 114 is configured to receive satellite positioning signals 132 from a satellite position system 134 such as, for example, the United States NAVSTAR GPS, the Russian counterpart to NAVSTAR known as Global Navigation Satellite System (“GLONASS”), and the future European system known as Galileo.

The cellular communication network 110 may be any wireless communication network that allows the wireless device 114 to communicate with the Internet 108. Examples of the cellular communication networks include TDMA, CDMA, and GSM communication networks operated by United States cellular providers AT&T Wireless, Verizon, T-Mobile, or Sprint Communications.

The agent 102 may be a human, robot, other type of machine, or combination of human and machine. If human, the agent 102 may be a shopper, tourist, helper, representative, or avatar. The agent 102 may be equipped with one or more devices (such as wireless device 114) which may include processors and/or systems such as a smartphone, computer tablet, portable computer, or other means, equipped or associated with one or more cameras, microphones, haptic sensors, and/or chemical sensors that are capable of sensing and transmitting to the user 100 audio, video, haptic and/or chemical information (e.g., odors) (“environmental information”) proximate to the agent 102 at the location of the agent 104.

The agent 102 may be any person willing to work as an agent for the user 100 which is registered with the service provider 128. As an example, the agent 102 may be a tourist traveling in a foreign country with a wireless device 114 (that may be, for example, a smartphone, computer tablet, or personal computer) that is willing to help the user 100 by either going to specific places of interest to the user 100 to, for example, record video and/or audio or take pictures for the user that can be transmitted to the user's 100 online device 109 or to do specific tasks that may include purchasing items, communication with third parties, or other telepresence activities.

Additionally, the agent 102 may be a person that possesses certain skills or knowledge that is beneficial to the user 100. Specifically, the agent 102 may have language skills (i.e., the agent 102 may speak and/or read and write the language of the user 100 and/or the foreign location where the agent 102 is located) or familiarity with culture, geography, history, political environment of the user 100 and/or the foreign location of the agent 102. In this example, the agent 102 may provide the service provider 129 with a list of the skills and knowledge of the agent 102. The service provider 128 may then store and categorize the list of skills and knowledge corresponding to the agent 102 in the server 136 database and then provide this information to the user 100 who may utilize this information in selecting a potential agent. Moreover, the agent 102 may continuously provide the service provider 128 with information regarding the environment of the agent 102 such that the service provider 128 may update its database regarding this information. This environmental information may also be passed to the user 100 by the server 136.

As discussed above, the wireless device 114 may be incorporated into the agent 102 as a wearable device such as, for example, a helmet, headpiece, or wearable accessory. Alternatively, the wireless device 114 may be able to communicate (for example, utilizing Wi-Fi®, Bluetooth®, or other signal communication means both wired and wireless) with the other devices discussed above. As an example, one or more cameras and/or microphones, which are capable of sensing and transmitting (alone or via the wireless device 114) environmental information in the location 104 of the agent 102 to the user 100 are mounted or otherwise associated in a helmet, hat, bandana and/or elsewhere on, attached to, or in close association with the agent 102. As a further example, multiple cameras and/or microphones may be arrayed around the agent 102. The cameras may be standard cameras or part of a three-dimensional camera system.

Alternatively, as an example, if the agent 102 is a robotic device, the robotic device may include a display capable of displaying images and/or audio of user 100 captured by the online device 109. In this manner a robotic device under the remote control of the user 100 may provide a communication means between the user 100 and store clerks and other persons, etc., encountered in places of interest to which the user 100 directs the agent 102.

The user 100 communicates with the agent 102 via the online device 109. As discussed earlier, the online device 109 may be any computing device capable of connecting to the Internet 108 and having a display 110 capable of showing images or video captured by wireless device 114 of the agent 102 or provided by the service provider 126. The online device 109 may be a personal computer, computer tablet, PDA, smartphone, or any other equivalent device. Additionally, the online device 109 may be configured to operate with one or more peripheral devices (not shown) that assist the user 100 in achieving a telepresence environment. Example peripheral devices may include multiple video displays (not shown), external speakers, external microphones, virtual reality glasses, and a virtual reality suit, all of which are in signal communication with the online device 109. The user 100 may also utilize the online device 109, or associated peripheral devices, to communicate and control aspects of the agent 102. For example, if the agent 102 possesses remote controllable cameras, the user 100 may control one of more of the cameras associated with the agent 102 such as, for example, the pan, tilt, zoom, mechanical position of the camera or cameras.

In general, the telepresence system also includes a client module (not shown), an agent module (not shown), and a server 136. The client module (not shown) may be in signal communication with the online device 109 of the user 100 and the agent module (not shown) may be in signal communication with the wireless device 114 of the agent 102. The server 136 may be in signal communication with the client module (not shown), agent module (not shown), and both the Internet 108 and wireless communication network 110 via signal paths 138 and 140, respectively. The server 136 may also be in signal communication with the service provider 128 via signal path 130. In general, the server 136 may be configured to receive requests from the user 100 via the Internet 108 and location information from the agent 102 via the cellular telecommunication network 110 and, in response, provide telepresence information from the agent 102 to the user 100. Typically, the server 136 may be part of the service provider 128.

The service provider 128 may be an entity or organization that provides the user 100 with telepresence services such as remote shopping services, remote travel services, remote event participation services, and the like. The service provider 128 may provide the user 100 (via a website on the Internet 108 that is shown to the user 100 through the online device 109) with list of available agents from which to choose a specific agent 102 to satisfy the telepresence needs of the user 100. Alternatively, the service provider 128 may be more limited to only providing a website on the Internet 108 (that may be viewed and interacted with via the online device 109) which the user 100 may utilize to contact and communicate with independent agents who provide telepresence services.

The service provider 128 may offer the list of available potential agents based on the locations (i.e., starting locations) of the individual potential agents relative to either the user 100 location 106 and/or the place(s) of interest (i.e., the target 124) to which the selected agent 102 will be directed by the user 100 so that an agent 102 may be selected that is close to the user 100 or the area(s) of interest to which the agent 102 will be directed. As an example, if the user 100 desires to engage the telepresence services of an agent 102 to remotely shop for the user 100 and purchase goods at a target 124 (for example, a local department store) that will be delivered by the agent 102 to the user 100, the user 100 may want to select an agent 102 that is nearby the location 106 of the user and/or the location 126 of the target 124 (i.e., the department store). In this example, the service provider 128 may limit the list of potential agents available to the user 102 to a sub-list of potential agents available to the user 102 based on the location 106 of the user and/or the location 126 of the target 124 (i.e., the place of interest to which the agent 102 will be directed by the user 100). The user 100 may then select the agent 102 from the sub-list of the potential agents available utilizing the online device 109. In order to assist the user 100 in selecting an agent 102, the service provider 128 may also provide the user 100 with additional information about each potential agent including the agent's qualifications, such as languages spoken, camera skills, number and types of cameras (whether three-dimensional or controllable), number and types of microphones, availability of other telepresence sensors, displays, and equipment, negotiation skills, travel knowledge, and/or rating by prior users, etc. This additional information may be displayed for the user 100 on the display 110 of the online device 109 to assist the user 100 in the selection of the agent 102 to provide the telepresence services to the user 100.

The service provider 128 may register potential agents and potential targets to which the user 100 may send an agent 102. In this example, the service provider 128 may create a database (not shown) of potential registered agents and their corresponding starting locations and potential registered targets and their target locations. This database (not shown) may be either in the server 136 or remote to and in signal communication with the server 136. The service provider 128 may then establish pre-determined positive location areas and pre-determined negative location areas that effect the transmission of information from the service provider 128 to the us the online device 109 of the user 100. Specifically, the service provider 128 may establish a pre-determined positive location area 142 that is a location area that triggers the transmission of information from the service provider 128 to the online device 109 of the user 100. Similarly, the service provider 128 may establish a pre-determined negative location area 144 that is a location area that triggers the termination of an existing transmission of information from the service provider 128 to the online device 109 of the user 100. Both the pre-determined positive location areas and pre-determined negative location areas may be pre-determined by the service provider 128 based on information received by the registered targets.

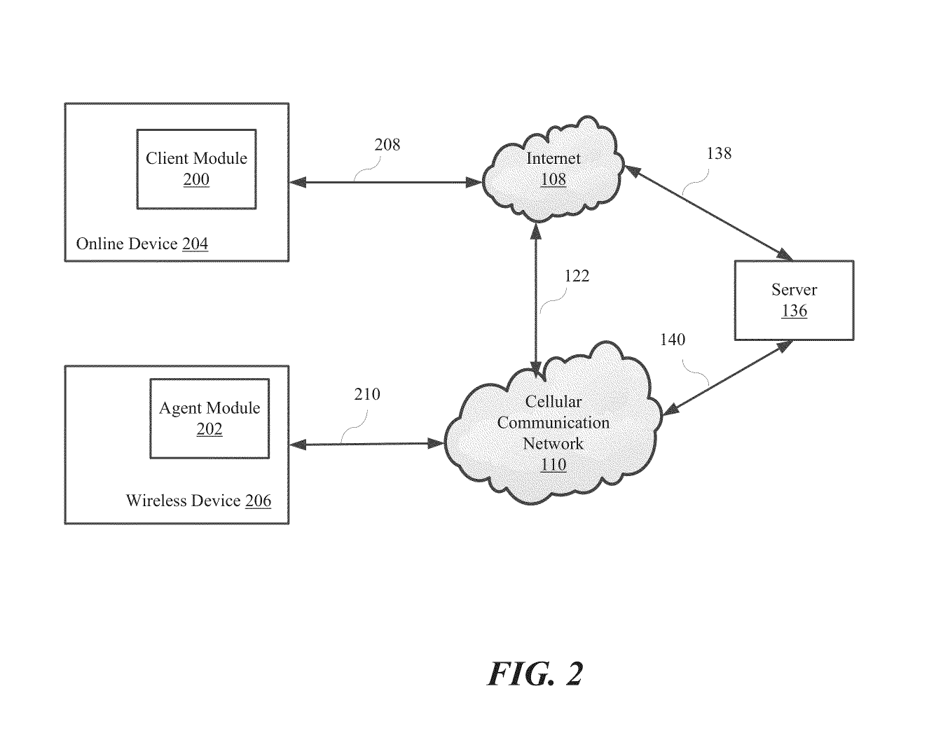

Turning to FIG. 2, in FIG. 2 a system block diagram is shown of the example of the implementation of the telepresence system, shown in FIG. 1, including a client module 200 and an agent module 202. Specifically, the telepresence system shown in FIG. 2 includes the client module 200 in signal communication with the online device 204 and the agent module 202 in signal communication with wireless device 206. In this example the online device 204 is in signal communication with the Internet 108 via signal path 208 and the wireless device 206 is in signal communication with the cellular communication network 110 via signal path 210. Similar to FIG. 1, the server 136 is in signal communication with both the Internet 108 and cellular communication network 110 via signal paths 138 and 140, respectively.

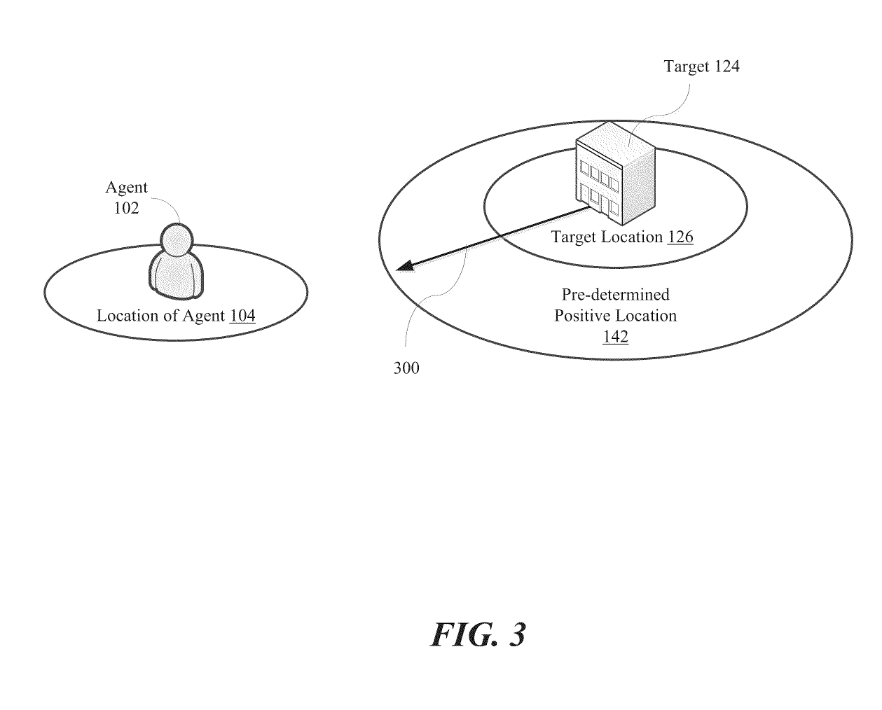

In FIG. 3, a perspective view of the respective locations 104 and 126 of the agent 100 and a registered target 124 are shown in relation to a pre-determined positive location 142, in accordance with the invention. In this example, if the registered target 124 is a business establishment or organization, the target 124 may desire to have business related information such as, for example, advertising information sent to the user 100 once the agent 102 of the user 100 enters within the pre-determined positive location area 142 that corresponds to the target location 126. In this example, the target 124 may send advertising information to the server 136 to send to users who have agents that enter into the pre-determined positive location area 142 corresponding to the target 124 where the pre-determined positive location area 142 is an extending circular area that extends out from the location 126 of the target 124 and has a radius 300.

In an example of operation, if the server 136 determines that the agent 104 enters into the pre-determined positive location area 142 (i.e., the location 104 of the agent 100 overlaps the pre-determined positive location area 142), the server 136 then transmits the business related information from the target 124 to the online device 109 of the user 100. The business related information may be advertising information such as, for example, electronic coupons.

In another example of operation, the telepresence system allows for real-time competition between competing businesses. As an example, if the user 100 directs the agent 102 to go to a first store in a shopping mall which also includes a second store belonging to a competitor (which is also registered with the service provider 128), the competitor may be able to have the service provider send the user 100 advertisements, electronic coupons, or other business related information that would entice the user 100 to send the agent 102 to the second store instead of the first store. In this example, the competitor may contract with the service provider to set up a plurality of pre-determined positive location areas to entice the user 100 such as a pre-determined positive location area within, for example, 100 feet of the first store and/or 2000 feet from the second store. In this type of example, there may be numerous stores registered with the service provider that each have one or more pre-determined positive location areas which may overlap other stores' pre-determined positive location areas. The end result being that the user 100 would receive multiple offers from different stores when the agent 102 enters an area that overlaps multiple pre-determined positive locations.

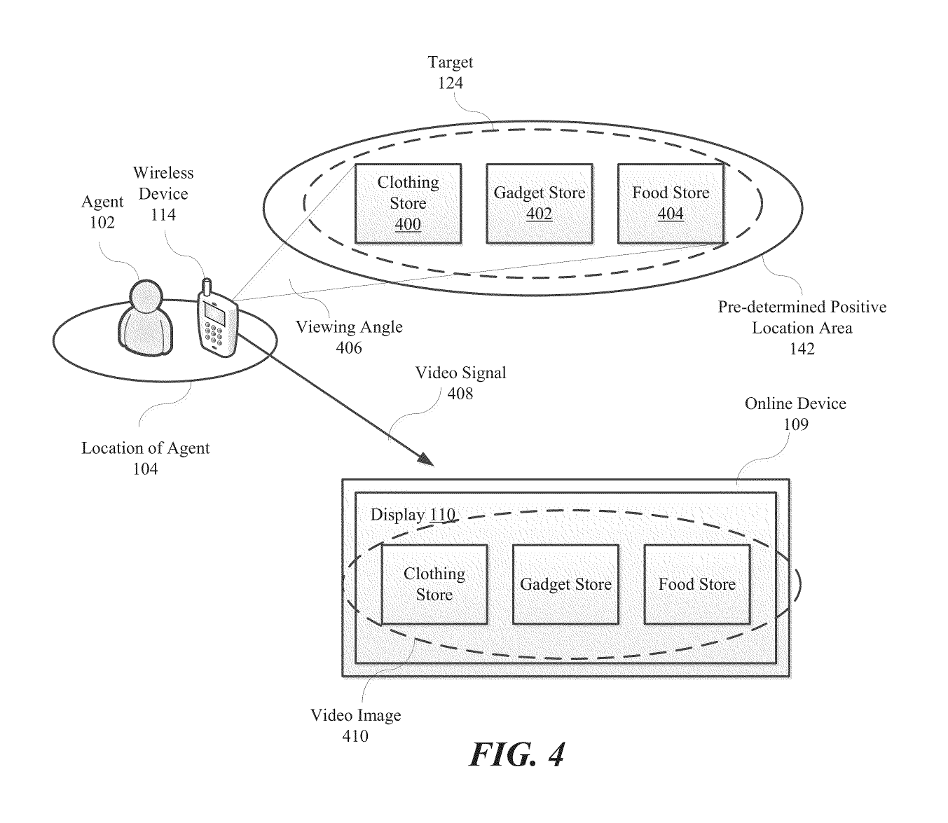

Turning to FIG. 4, FIG. 4 shows a system view of an example of a video transmission from an agent 104 to an online device 109 of a user 100 utilizing the telepresence system shown in FIG. 1. In this example, the agent 100 is outside of the pre-determined positive location area 142 and taking pictures and/or video of the front of target 124 which includes a clothing store 400, gadget store 402, and food store 404. The agent 102 utilizes a camera (not shown) on the wireless device 114 to take video of the front of the target 124 with a viewing angle 406 that includes the clothing store 400, gadget store 402, and food store 404 within the viewing plane of the camera. The camera creates a video signal 408 that is transmitted to the online device 109 and displayed as a video image 410, on display 110 of the online device 109, showing the clothing store 400, gadget store 402 of the target 124. As described earlier, the video image 410 is telepresence information that is transmitted from the agent 102 to the user 100, which the user 100 may utilize in determining where to send the agent 102. If the user 100 desires clothes, the user 100 instructs the agent 102 to proceed to the clothing store 400. Similarly, if, instead, the user 100 desires either a gadget or some food, the user may instruct the agent 102 to proceed to the gadget store 402 or food store 404, respectively.

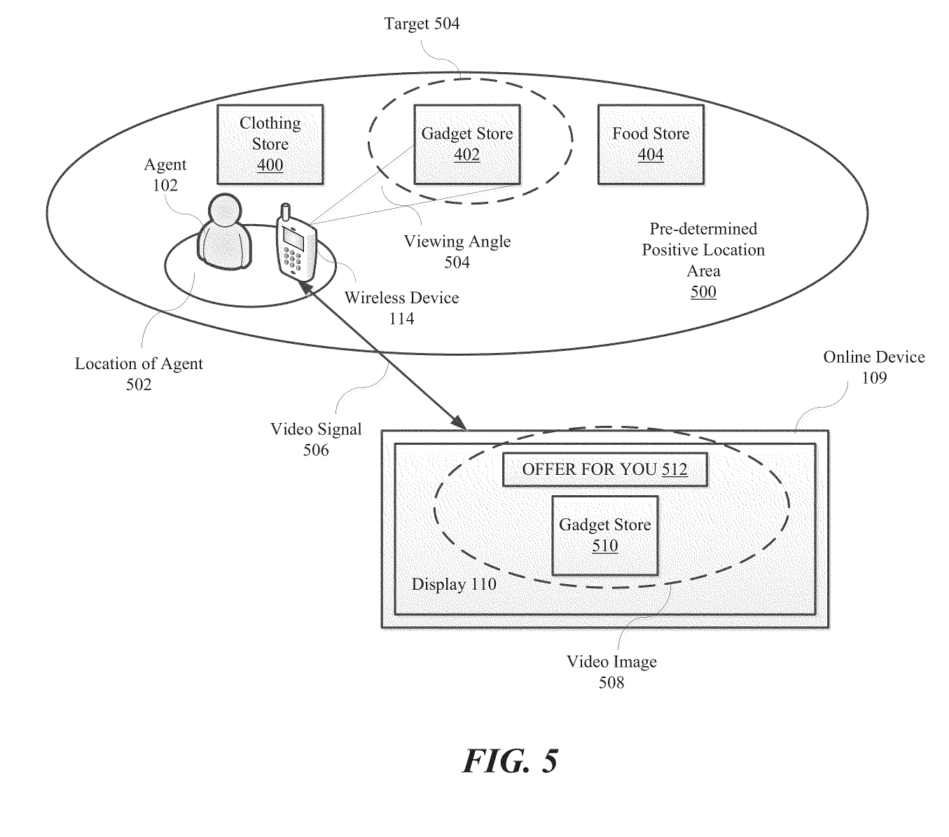

Expanding on the example described in FIG. 4, in FIG. 5, a system view is shown of an example of a video transmission from the agent 100 and service provider 128 to the online device 109 of the user 100 when the agent 102 enters into the pre-determined positive location area 142 utilizing the telepresence system. In this example, the user 100 has decided to send the agent 100 to the gadget store 402, which is a registered target of the service provider 128. Once the agent 102 enters into the pre-determined positive location area 500 of the gadget store 402, the wireless device 114 of the agent 102 transmits its new location 502. Once the server 136 receives the new location 502 of the agent 102, it determines that the location 502 of the agent 102 is within the pre-determined positive location are of the gadget store 402 (i.e., the target 504) and in response sends the user 100 advertising and/or sale information corresponding to the gadget store 402. If the agent 102 utilizes the camera of the wireless device 114 to video the front of the gadget store 402 with a viewing angle 504, camera creates a video signal 506 that is transmitted to the online device 109. However, unlike the example given in FIG. 4, in this example the service provider 128 also provides advertising and/or sale information corresponding to the gadget store 402 which is combined with the video signal 506 to produce a video image 508 on the display 110 of the online device 109 that includes an image of gadget store 510 and an advertising and/or sale image 512 having advertising and/or sale information related to the gadget store 402.

The advertising and/or sale information may be time limited such that, for example, sale prices are only good if the agent 102 enters the gadget store 402 within a certain time and purchases a sales item. The server 136 is capable of keeping track of sales offers from targets to one or more agents that are conditional on location or time.

In a social, non-business application, the service provider 128 may register individuals in a social club or organization. The service provider 128 may then use pre-determined positive location areas to determine if a member's agent 102 is near another member and/or another member's agent (not shown). If yes, the service provider 128 may notify both members and offer to start either direct communication between the members or indirect communication between agent-and-member or agent-and-agent. A possible application for this would be when one member needs to give an item to another member. In this example, the first member may give the item to the second member's agent who will them take the item to the second member.

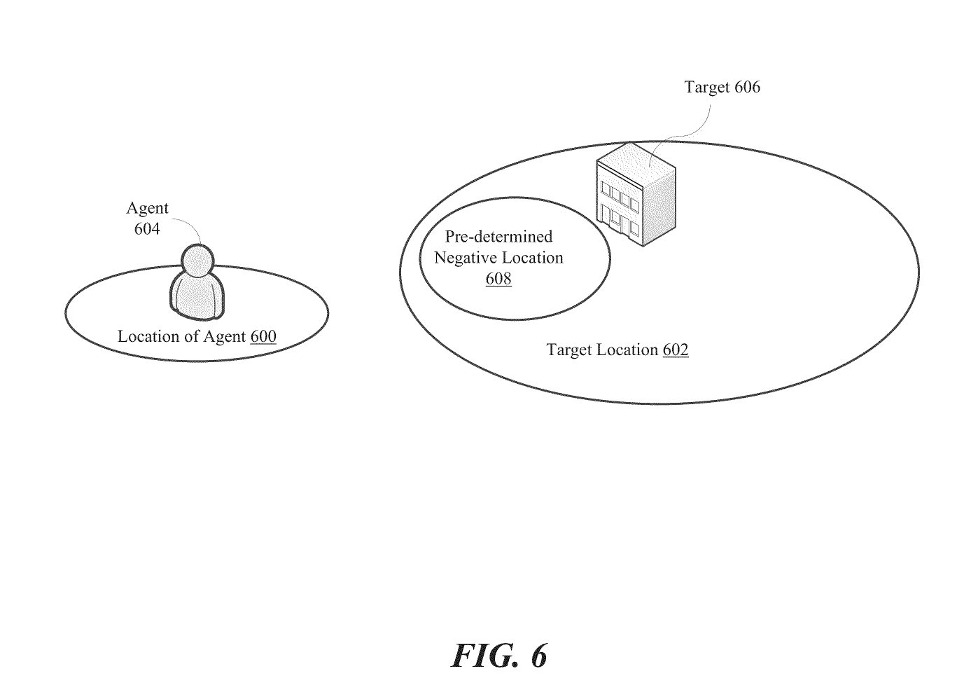

Turning to FIG. 6, in FIG. 6 a perspective view of the respective locations 600 and 602 of the agent 604 and a registered target 606 are shown in relation to a pre-determined negative location 608 in accordance with the invention. In this example, if the registered target 606 desires to have one or more pre-determined negative location areas 608 blocked from the user 100, the target 606 sends that information to the service provider 128. In this example, if the agent 604 is transmitting telepresence information to the user 100 and the server 136 determines that the agent 604 has entered into the pre-determined negative location 608, the server 136 terminates transmission of some or all telepresence information from the agent 604 to the online device 109 of the user 100. An example of this application would be if the target 606 designates a washroom, changing/locker room, or other sensitive area as a pre-determined negative location area 608. In this example, the target 606 may condition what type, if any, telepresence information may be transmitted from the agent 604 to the user 100. As an example, the target 606 may allow the transmission of audio without video in a washroom or changing room but not in a place like a concert hall or meeting room. The pre-determined negative location areas 608 may be designated to protect privacy, personal information, copyrighted material, etc.

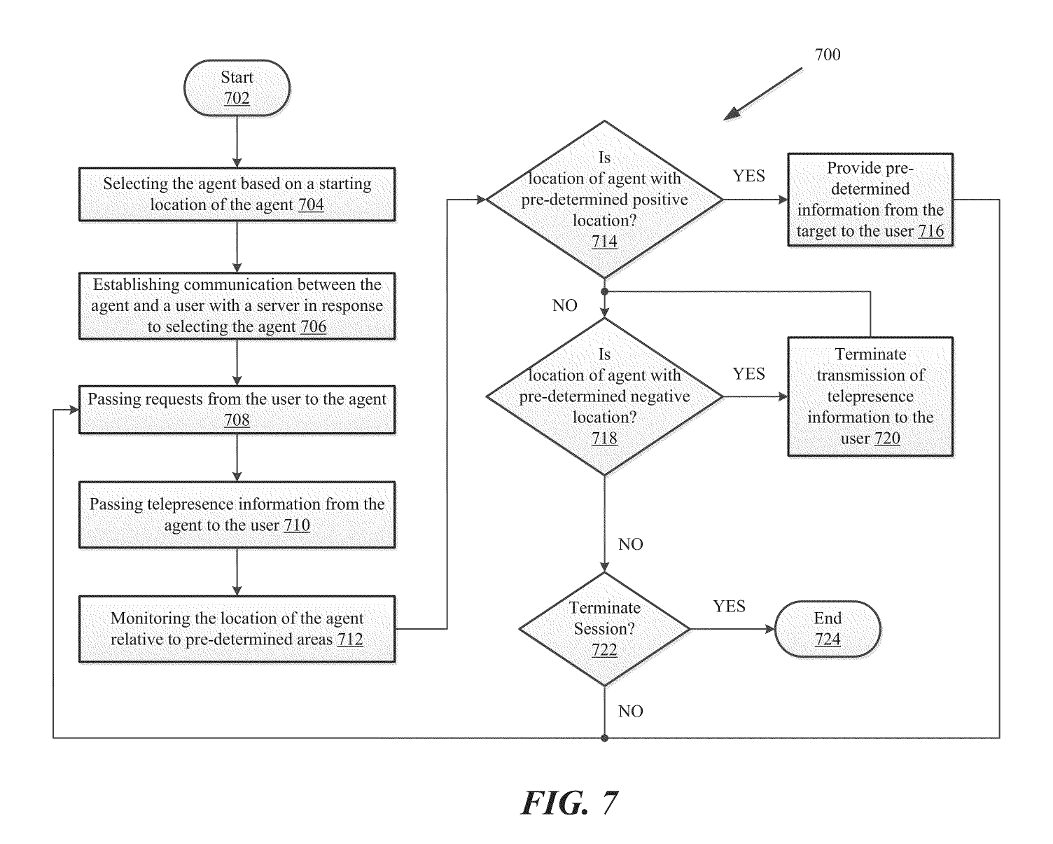

In FIG. 7, a flowchart 700 of an example of an implementation of a process performed by the telepresence system of FIG. 1 is shown in accordance with the invention. In general, the telepresence system allows a user to establish a telepresence with an agent via the Internet and a cellular communication network. In an example of operation, the telepresence system performs a process that starts 702 by establishing communication between the user and the agent via the Internet and cellular communication network. The process establishes this communication by selecting the agent based on a starting location of the agent in step 704 where this includes selecting the agent based on the starting location of the agent relative to the either a location of the user or a location of target. This selection may be done in combination between the user and the service provider. Then in step 706, in response to the agent selection, a server establishes communication between the user and the agent. Once communication is established between the agent and user, the server receives requests from the user and passes them to the agent in step 708. In response to the user's requests, the agent gathers telepresence information and sends it to the server which in step 710 passes it to the user. The server then monitors the location of the agent in step 712 using location information provided by the agent's wireless device and compares it to various pre-determined areas (both positive and negative) provided by different registered potential targets. In decision step 714, the server checks to see if the agent has entered into a pre-determined positive location area of a registered target. If the answer is yes, in step 716, the server provides to the user pre-determined information, which was provided to the service provider by the target. The process then continues to step 708 and repeats.

If, instead, the answer is no, the process continues to decision step 718 where the server checks to see if the agent has entered into a pre-determined negative location area of the registered target. If the answer is yes, in step 720, the server terminates the transmission of at least some telepresence information from the agent to the user. The process then repeats decision step 718, where the server continues to regularly compare the location of the agent against the pre-determined negative location area to see if agent is still located in the pre-determined negative location. If the agent leaves the pre-determined negative location area, the process travels from decision step 718 to decision step 722.

If, instead, the answer is no, the process continues to decision step 722 where the server check to see if the user or agent have terminated the session. If the answer is yes, the process ends 724. If, instead, the answer is no, the process repeats by returning to step 708.

Although the previous description only illustrates particular examples of various implementations, the invention is not limited to the foregoing illustrative examples. A person skilled in the art is aware that the invention as defined by the appended claims can be applied in various further implementations and modifications. In particular, a combination of the various features of the described implementations is possible, as far as these features are not in contradiction with each other. Accordingly, the foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for a user to establish telepresence with an agent via the Internet and a cellular communication network, the method comprising:
establishing communication between the user and the agent via the Internet and cellular communication network;
passing requests from the user to the agent via an online device in signal communication with the Internet; and
passing telepresence information from the agent to the user via a wireless device in signal communication with the cellular network, wherein the cellular communication network is in signal communication with the Internet.

2. The method of claim 1, wherein establishing communication between the user and the agent includes selecting the agent based on a starting location of the agent.

3. The method of claim 2, wherein selecting the agent based on a starting location of the agent includes selecting the agent based on the starting location of the agent relative to the either a location of the user or a location of a target.

4. The method of claim 3,
wherein selecting the agent on the starting location of the agent results in a plurality of potential agents being selected and
wherein selecting the agent on the starting location of the agent further includes receiving a request from the user, via the online device, for the agent from the selected plurality of potential agents.

5. The method of claim 3, wherein establishing communication between the user and the agent further includes establishing communication between the user and the agent via a server that is in signal communication with both the user via the Internet and the agent via the cellular communication network.

6. The method of claim 5,
wherein the server includes a database of a plurality of registered potential agents,
wherein the server receives a starting location from each registered potential agent, and
wherein the server selects the plurality of potential agents based on the plurality of starting locations corresponding to the plurality of registered potential agents.

7. The method of claim 6,
wherein the server is in signal communication with a service provider,
wherein the service provider registers the plurality of registered potential agents,
wherein the service provider registers the user having a user location, and
wherein the service provider registers a target having a target location.

8. The method of claim 7, wherein passing requests from the user to the agent includes
receiving a request from the user at the server via the Internet, and
transmitting the request to the agent via cellular communication network.

9. The method of claim 8, wherein passing telepresence information from the agent to the user includes
receiving telepresence information from the agent via the cellular communication network, and
transmitting the telepresence information to the user via the Internet.

10. The method of claim 9, wherein the telepresence information includes video, audio, haptic, chemical, and textual information.

11. The method of claim 7,
wherein passing requests from the user to the agent includes passing the requests directly to the agent without passing through the server, and
wherein passing telepresence information from the agent to the user includes passing the telepresence information directly to the user without passing through the server.

12. The method of claim 11,
wherein the online device of the user includes a client module, and
wherein the wireless device of the agent includes an agent module, and
wherein the client module and agent module are each configured to communicate with the server, each other, or both.

13. The method of claim 7, wherein the service provider establishes a pre-determined positive location related to the target location of the target.

14. The method of claim 13, wherein pre-determined positive location area is defined by a pre-determined positive location area that includes the target location.

15. The method of claim 14, wherein the pre-determined positive location area is defined by a radius that extends out from target location.

16. The method of claim 13, wherein the server
receives location information from the wireless device of the agent, wherein the location information defines a location of the agent,
determines whether the location of the agent is within the pre-determined positive location area, and
transmits information related to the target to the user, via the Internet, if the server determines that the location of the agent is within the pre-determined positive location area.

17. The method of claim 16, wherein the target is a business and the information related to the target includes business related information about the target.

18. The method of claim 17, wherein business related information includes electronic coupons.

19. The method of claim 13, wherein the server
receives location information from the wireless device of the agent, wherein the location information defines a location of the agent,
determines that the location of the agent is not within the pre-determined positive location area, and
passes telepresence information related to the location of the agent, via the Internet, to the user.

20. The method of claim 19, wherein the telepresence information includes video and audio information and the video is configured to be displayed on a display corresponding to the online device of the user.

21. The method of claim 7, wherein the service provider establishes a pre-determined negative location area related to the target location of the target.

22. The method of claim 21, wherein the server
receives location information from the wireless device of the agent, wherein the location information defines a location of the agent,
determines whether the location of the agent is within the pre-determined negative location area, and
terminates transmission of information related to the location of the agent to the user, via the Internet, if the server determines that the location of the agent is within the pre-determined negative location area.

23. A telepresence system for providing information to a user through an agent based on the location of the agent, which is remote to a location of the user, wherein the telepresence system is in signal communication with the Internet and a wireless communication network, the telepresence system comprising:
a client module in signal communication with an online device of the user;
an agent module in signal communication with a wireless device of the agent;
a server in signal communication with the client module, agent module, and both the Internet and wireless communication network,
wherein the server is configured to
receive requests from the user via the Internet,
receive location information from the agent via the cellular telecommunication network, and
provide telepresence information from the agent to the user.

24. The telepresence system of claim 23, wherein the server is further configured to
compare a location of the agent, provided by the received location information from the agent, with a pre-determined positive location area, and
transmit information related to a target to the user, via the Internet, if the server determines that the location of the agent is within the pre-determined positive location area.

25. The telepresence system of claim 24, wherein the target is a business and the information related to the target includes business related information about the target.

26. The telepresence system of claim 25, wherein business related information includes electronic coupons.

27. The telepresence system of claim 23, wherein the server is further configured to
compare a location of the agent, provided by the received location information from the agent, with a pre-determined positive location area, and
passes telepresence information related to the location of the agent, via the Internet, to the user when the server determines that the location of the agent is not within the pre-determined positive location area.

28. The telepresence system of claim 27, wherein the telepresence information includes video and audio information and the video is configured to be displayed on a display corresponding to the online device of the user.

29. The telepresence system of claim 23, wherein the server is further configured to
compare a location of the agent, provided by the received location information from the agent, with a pre-determined negative location area, and
terminate transmission of telepresence information related to the location of the agent, via the Internet, to the user when the server determines that the location of the agent is within the pre-determined negative location area.
